(19) United States
(12) Patent Application Publication
(10) Pub. No.: US 2012/0004849 A1
(43) Pub. Date: Jan. 5, 2012

(54) EFFICIENT WINDOWED RADON TRANSFORM

(75) Inventor: Victor AARRE, Stavanger (NO)

(73) Assignee: SCHLUMBERGER TECHNOLOGY CORPORATION, Sugar Land, TX (US)

(21) Appl. No.: 12/940,469

(22) Filed: Nov. 5, 2010

Related U.S. Application Data
(60) Provisional application No. 61/316,127, filed on Mar. 22, 2010.

(51) Int. Cl. G06F 19/00; G01V 1/24; G06F 17/18

(52) U.S. Cl. 702/14; 702/179; 702/2

(57) ABSTRACT

One or more computer-readable media including computer-executable instructions to instruct a computing system to define a Radon transform convolution mask; specify an angle that defines a line extending at least partially across a pixel image; and apply the mask successively to target pixels on the line to compute a statistical value for each of the target pixels where application of the mask identifies a set of pixels for computing the statistical value and where each successive application of the mask identifies a set of pixels that includes at least one pixel of a prior set and at least one pixel not included in the prior set to thereby reduce requirements for computing the statistical values. Various other apparatuses, systems, methods, etc., are also disclosed.

### RELATED APPLICATIONS

This application claims the benefit of U.S. Provisional Application having Ser. No. 61/316,127 entitled “Fault Line Detection,” filed Mar. 22, 2010, which is incorporated by reference herein.

### BACKGROUND

The Radon transform has proven to be a useful technique for tasks such as finding lines in images. For example, to find lines in an image, a conventional windowed Radon transform technique rotates a line a number of degrees about each pixel to determine the angle that includes pixels most representative of a line. Such a conventional brute force approach for an image dimensioned M×N has a computational complexity on the order of l*A*M*N, which l is the length of the line in pixels and A is the number of angles. As described herein, various approaches can reduce computational requirements for application of the Radon transform.

### SUMMARY

One or more computer-readable media including computer-executable instructions to instruct a computing system to define a Radon transform convolution mask; specify an angle that defines a line extending at least partially across a pixel image; and apply the mask successively to target pixels on the line to compute a statistical value for each of the target pixels where application of the mask identifies a set of pixels for computing the statistical value and where each successive application of the mask identifies a set of pixels that includes at least one pixel of a prior set and at least one pixel not included in the prior set to thereby reduce requirements for computing the statistical values. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a reservoir;

FIG. 2 illustrates an example of a method for identifying features in data;

FIG. 3 illustrates an example of crack detection in seismic data;

FIG. 4 illustrates an example of a method for applying a Radon transform mask;

FIG. 5 illustrates an example of a method for moving a mask along lines disposed at various angles to select optimal angles;

FIG. 6 illustrates an example of a method for analyzing data using the Radon transform;

FIG. 7 illustrates an example of a method that includes skewing data;

FIG. 8 illustrates trial results as time versus line length;

FIG. 9 illustrates an example of mask statistics and an example of a 3D implementation; and

FIG. 10 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

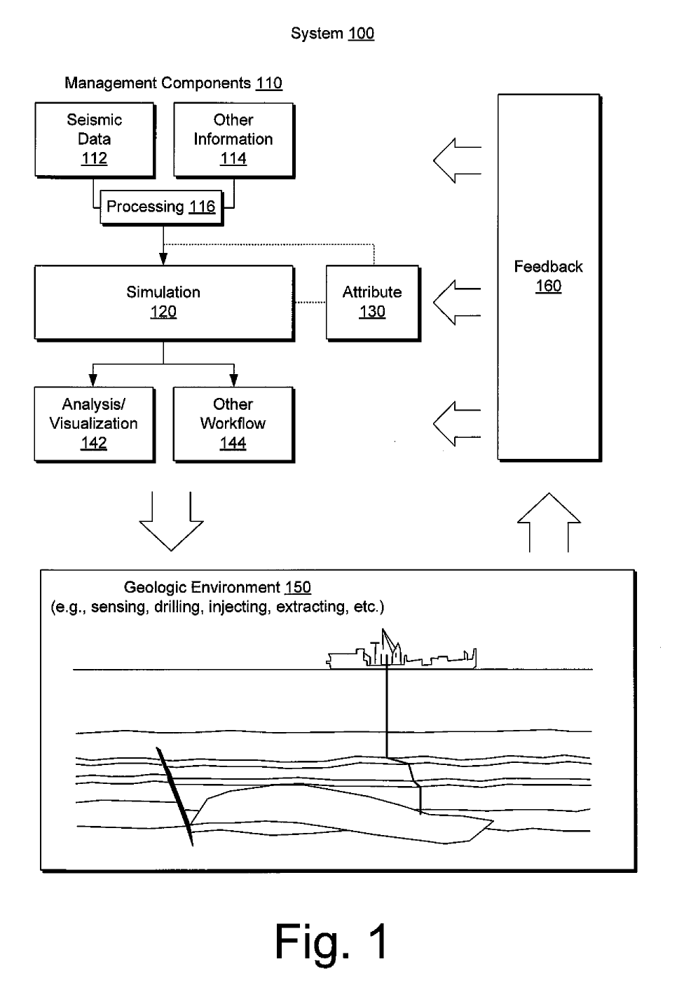

FIG. 1 shows an example of a system 100 that includes various management components 110 to manage various aspects of a geologic environment 150. For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an information component 114, a processing component 116, a simulation component 120, an attribute component 130, an analysis/visualization component 142 and a workflow component 144. In operation, seismic data and other information provided per the components 112 and 114 may be input to the simulation component 120, optionally after processing via the processing component 116, which may be configured to implement a Radon transform for processing seismic data.

The simulation component 120 may process information to conform to one or more attributes, for example, as specified by the attribute component 130, which may be a library of attributes. Such processing may occur prior to input to the simulation component 120 (e.g., per the processing component 116). Alternatively, or in addition to, the simulation component 120 may perform operations on input information based on one or more attributes specified by the attribute component 130. As described herein, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results. Additionally, or alternatively, output from the simulation component 120 may be input to one or more other workflows, as indicated by a workflow component 144.

As described herein, the management components 110 may include features of a commercially available simulation framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes.

As described herein, the management components 110 may include features for geology and geological modeling to generate high-resolution geological models of reservoir structure and stratigraphy (e.g., classification and estimation, facies modeling, well correlation, surface imaging, structural and fault analysis, well path design, data analysis, fracture modeling, workflow editing, uncertainty and optimization modeling, petrophysical modeling, etc.). Particular features may allow for performance of rapid 2D and 3D seismic interpretation, optionally for integration with geological and engineering tools (e.g., classification and estimation, well path design, seismic interpretation, seismic attribute analysis, seismic sampling, seismic volume rendering, geobody extraction, domain conversion, etc.). As to reservoir engineering, for a generated model, one or more features may allow for simulation workflow to perform streamline simulation, reduce uncertainty and assist in future well planning (e.g., uncertainty analysis and optimization workflow, well path design, advanced gridding and upscaling, history match analysis, etc.). The management components 110 may include features for drilling workflows including well path design, drilling visualization, and real-time model updates (e.g., via real-time data links).

As described herein, various aspects of the management components 110 may be add-ons or plug-ins that operate according to specifications of a framework environment. For example, a commercially available framework environment marketed as the OCEAN® framework environment (Schlumberger Limited) allows for seamless integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. As described herein, various components may be implemented as add-ons (or plug-ins) that conform to and operate according to specifications of a framework environment (e.g., according to application programming interface (API) specifications, etc.). Various technologies described herein may be optionally implemented as components in an attribute library.

In the field of seismic analysis, aspects of a geologic environment may be defined as attributes. In general, seismic attributes help to condition conventional amplitude seismic data for improved structural interpretation tasks, such as determining the exact location of lithological terminations and helping isolate hidden seismic stratigraphic features of a geologic environment. Attribute analysis can be quite helpful to defining a trap in exploration or delineating and characterizing a reservoir at the appraisal and development phase. An attribute generation process (e.g., in the PETREL® framework or other framework) may rely on a library of various seismic attributes (e.g., for display and use with seismic interpretation and reservoir characterization workflows). At times, a need or desire may exist for generation of attributes on the fly for rapid analysis. At other times, attribute generation may occur as a background process (e.g., a lower priority thread in a multithreaded computing environment), which can allow for one or more foreground processes (e.g., to enable a user to continue using various components).

Attributes can help extract the maximum amount of value from seismic and other data, for example, by providing more detail on subtle lithological variations of a geologic environment (e.g., an environment that includes one or more reservoirs).

In general, an accurate reconstruction of paleostress can be difficult to achieve for a geologic environment. In particular, stress magnitudes can be difficult to reconstruct based on borehole data (e.g., as acquired over a field grid). Stress magnitudes are helpful to understand and exploit resources in reserves such as carbonate reserves, which are estimated to hold more than 60% of the world's oil and 40% of the world's gas reserves. For example, consider that the Middle East has an estimated 62% of the world's proved conventional oil reserves where more than 70% of these reserves are in carbonate reservoirs and that the Middle East has an estimated 40% of the world's proved gas reserves where 90% of these gas reserves lie in carbonate reservoirs.

Unlike sandstones, with their well-characterized correlations of porosity, permeability, and other reservoir properties, heterogeneous pore systems of carbonate rocks can defy routine petrophysical analysis. Carbonates are deposited primarily through biological activity where the resulting rock composition (e.g., of fossil fragments and other grains of widely varying morphology) produces highly complex pore shapes and sizes. Carbonate mineral species are also comparatively unstable and are subjected to multiple stages of dissolution, precipitation, and recrystallization, adding further complexity to the porosity and permeability of the rocks. Further, comparatively simple relationships that might have existed between depositional attributes, porosity, and permeability can be obscured by such physical, biological, and chemical influences, operating at different scales, during and continuing after deposition. One challenge for accurate evaluation of carbonate formations is accounting for reservoir heterogeneity on a multiplicity of scales (e.g., of grains, pores, and textures).

In the oil and gas industry, existing approaches for detection of faults, fractures and estimation of possible stress in layers close to the surface sometimes include analysis of attributes based on local dip angle for the surface, attributes based on local azimuth angle for the surface and attributes based on curvature of a single surface. As described herein, various techniques that rely on the Radon transform can enhance identification of cracks, faults, discontinuities, etc., which, in turn, can provide for a more comprehensive understanding of a reservoir environment. While various examples are described with respect to analysis of seismic data, techniques may be used for other types of data especially where implementation of the Radon transform may benefit from reduction in requirements for computational resources.

The Radon transform may be implemented in the system 100 for tasks such as identifying cracks in the seabed or other geologic environment. Seismic data may be generated by transmitting sound energy in an environment and measuring energy responsive to such transmission, reflections, etc. The measured energy may be used to generate an image (e.g., similar to a technique used for ultrasounds), which may be referred to as a seismic image. A seismic image may be processed using any of a variety of techniques prior to application of the Radon transform. For example, one or more edge enhancement techniques may be applied to removes interface and enhance the irregularities (e.g., subtraction of an offset image).

In various conventional applications of the Radon transform, runtime is dependent on image size, line length searched for and the number of angles. The line length and the number of angles are often about the same size which makes the runtime increase as a quadratic polynomial dependent on line length, if the image size is fixed.

As described herein, the Radon transform is implemented with a moving mask (e.g., a sliding window) that can reuse elements. Such an approach can be referred to as a type of windowed Radon transform. A conventional Radon transform approach may be applied to look for features (e.g., lines, edges, etc.) spanning an entire image while a windowed radon transform approach may be applied to look for features (e.g., lines, edges, etc.) in small windows within an image. As described herein, window or mask size can be determined by a line-length parameter. In a windowed approach, a general Radon transform may be applied to every small window, subset or partition of an image. The term “Radon transform” is used generally herein, for example, as including windowed approaches.

As described herein, a “sliding-window” (or sliding mask) can be implemented as part of a windowed Radon transform approach to data analysis (e.g., edge detection, etc.). Theoretically, such an approach may make the algorithm linearly dependent on line length. Various techniques for optimization are also described herein. In various examples described herein, mask size (or window size) is based on a line length where elements (e.g., pixels, voxels, etc.) are selected to determine a value or values for a single element of interest positioned along the line (e.g., a center element). The selected elements also depend on line angle with respect to the element of interest. Variations of such an approach may be implemented as well (e.g., consider a variation where blocks of pixels values are averaged to create “elements”, etc.).

A particular approach aims to turn mean values into discernable lines via a peak detection process. For example, the result of the transform can be scanned for pixels that are greater in magnitude than their surroundings. Various approaches described herein can optionally decrease computational requirements while keeping noise to an acceptable level.

Various examples refer to fault line detection and more particularly to automatic fault line detection in 2D seismic images. This is a well-known problem in the hydrocarbon energy industry, because the presence of faults in, or around, a reservoir can impact reservoir production performance. Fault line detection is recognized as being a complex problem, where improvements are still actively being sought. A particular approach to fault line detection includes choosing preferred line segments based on both semblance (e.g., mean) and normalized variance, and optionally also based on consistent dip direction between neighboring line segments; improving runtime of such an algorithm by calculating running sums and variances; and calculating running sums in a skewed image, generated through an integer coordinate transform.

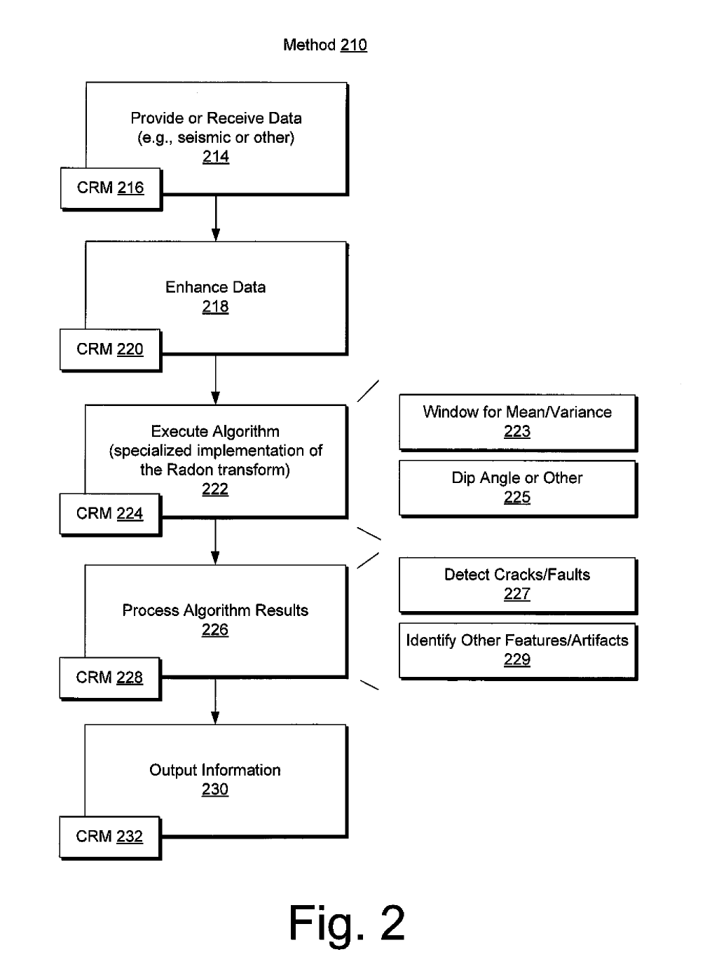

FIG. 2 shows an example of a method 210. The method 210 includes a provision or reception block 214 for providing data or for receiving data (e.g., or accessing data). An enhancement block 218 may apply one or more techniques to enhance the provided data. For example, an edge enhancement technique may be applied to enhance edges in the provided data. An execution block 222 executes an algorithm such as a specialized form of the Radon transform described in various examples herein. As indicated in FIG. 2, the execution block 222 may implement a mask 223 that selects data for determining mean, variance or mean and variance. Further, the execution block 222 may rely on dip angle or other information associated with the provided data. Dip angle is generally defined as an angle normal to the surface of a geologic environment where the angle is measured with respect to a line extending outwardly from the center of the Earth. Dip angle may vary smoothly over a surface and may change abruptly at a fault.

The method 210 also includes a process block 226 for processing results of the executed algorithm. Such processing may be optional. Such processing may include global optimization, for example, where a global cost function is applied to all of the results (e.g., to minimize variation of results from pixel to pixel, to maximize mean and variance results for each pixel, etc.). A global cost function may aim to minimize the number of lines or the directions of the lines to ensure that major cracks or faults are well-marked. As indicated in FIG. 2, a detection block 227 may apply techniques to enhance crack or fault detection and an identification block 229 may aim to identify other features or artifacts. An output block 230 provides for outputting information from the method 210, which may be subsequently used to direct one or more other processes (e.g., exploration, production, etc.).

The method 210 is shown in FIG. 2 in association with various computer-readable media block 216, 220, 224, 228 and 232. Such blocks generally include instructions suitable for execution by one or more processors (or cores) to instruct a computing device to perform one or more actions. While various blocks are shown, a single medium may be configured with instructions to allow for, at least in part, performance of various actions of the method 210.

As described herein, one or more computer-readable media can include computer-executable instructions to instruct a computing system to: receive data about a geologic environment (see, e.g., blocks 214 and 216); optionally enhance the data using an edge enhancement technique (see, e.g., blocks 218 and 220); execute the Radon transform with a convolution mask that moves along lines defined by angles to generate results (see, e.g., blocks 222 and 224); process results of the Radon transform to identify geological features and artifacts in the data (see, e.g., blocks 226 and 228); and output information sufficient to render the identified geological features to a display (see, e.g., blocks 230 and 232). As described herein, artifacts may be considered noise. As described herein, instructions may be provided to instruct a computing system to compute mean and variance and to identify lines as being characterized by a high mean and a low variance and to identify noise (e.g., speckle noise) as being characterized by a high mean and a high variance.

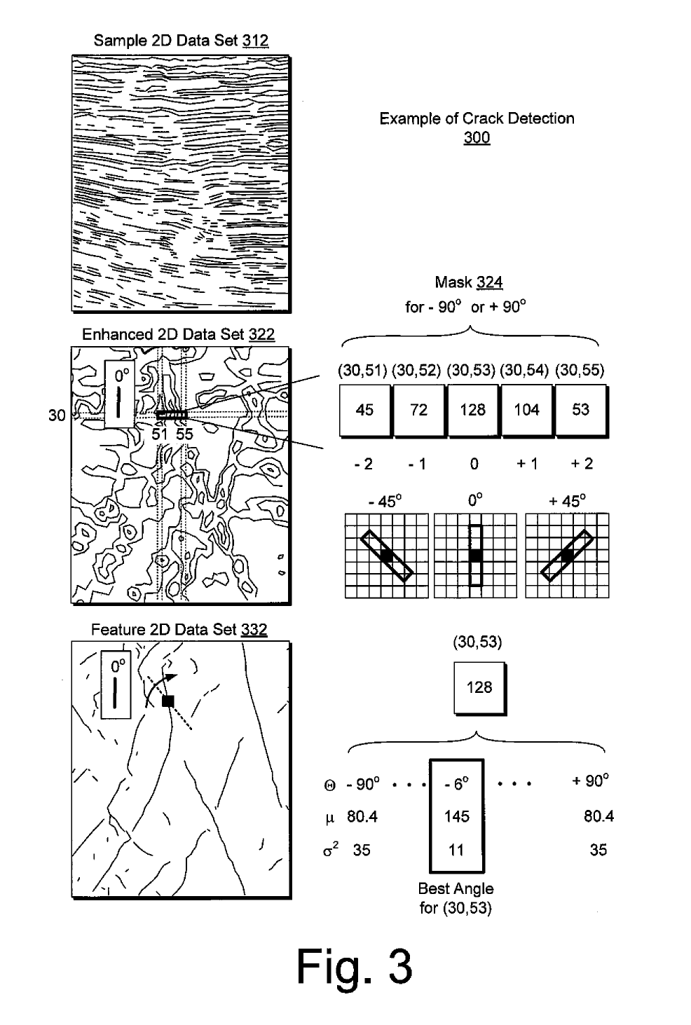

FIG. 3 shows an example 300 of crack detection in seismic data. As shown, a sample 2D data set 312 is provided, which represents seismic data (e.g., a seismic image). An edge enhanced 2D data set 322 illustrates various pixel intensity contours generated by application of an edge enhancement technique to the seismic data 312. FIG. 3 shows an example of a mask 324 having a length that corresponds to five pixels along an angle of +90° or −90°. As shown, each pixel has an intensity value (e.g., on a scale of 1 to 128 or 0 to 255, etc.). As indicated, the mask 324 may be applied along other angles, however, it should be noted that the number of pixels may vary depending on the angle where pixels are represented as having “dimensions”. Once the mask has been applied at various angles, a mean and a variance value exist for a pixel at each of the angles. In the example of FIG. 3, the best angle is selected as the one having the highest mean and the lowest variance. In other words, the edge enhancement has transformed the seismic data into a data set where high intensity corresponds to a crack. Therefore, in a relative manner, the angle with high intensity and lowest variance for a given pixel can be expected to correspond to a mask length that is aligned with a crack (i.e., high intensity pixels in the edge enhanced data 322).

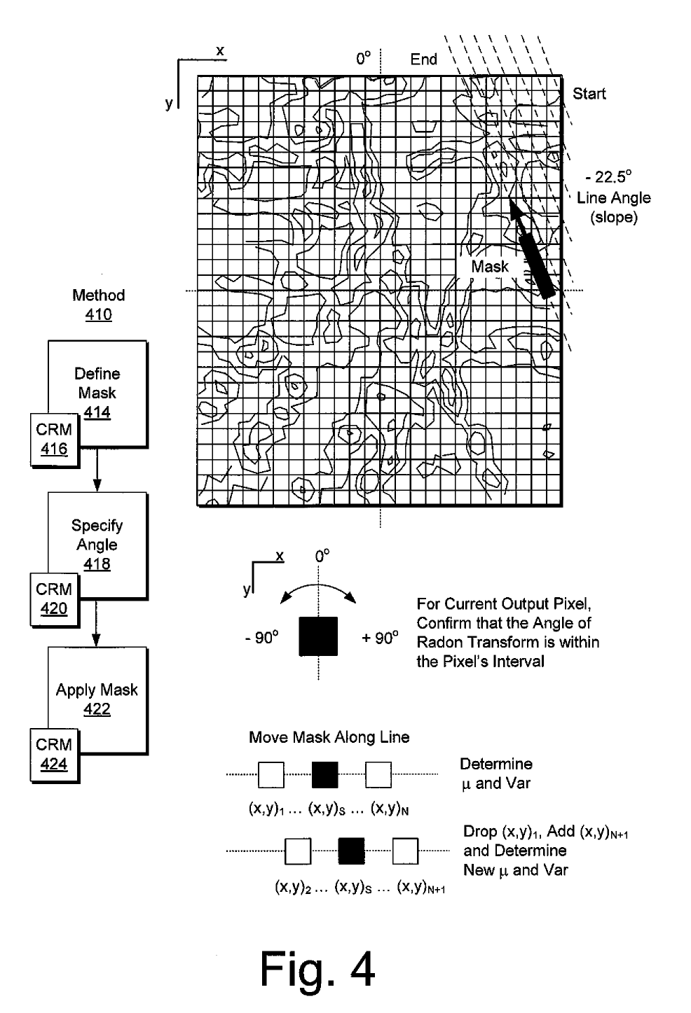

FIG. 4 shows an example of a method 410 that includes defining a mask (per definition block 414), specifying an angle (per specification block 418) and applying a mask (per application block 422). In an accompanying approximate graphic, lines are shown as extending across the edge enhanced data 322 of FIG. 3. A mask is shown as progressing along a line from a start boundary to an end boundary. As explained, the angle of the line may be checked to see if it corresponds to an angle interval of interest for a pixel. In various examples, the angles or lines specified for traversing a data set may be assumed to be of interest for a pixel absent any particularly additional information that may aim to limit the angle interval for a pixel (e.g., due to observation of major cracks/faults or dip angles in a region).

An approximate graphic in FIG. 4 also illustrates moving the mask along the line in a manner to determine mean and variance. As the mask is advanced, in a direction along a line from one target pixel to another target pixel, the mask acts to select a new set of pixels where the new set includes at least some of the pixels from the prior set to expedite computation of mean and variance for the new target pixel (or coordinate). As shown, new data is added while at least some old data is dropped.

The method 410 is shown in FIG. 2 in association with various computer-readable media block 416, 420, and 424. Such blocks generally include instructions suitable for execution by one or more processors (or cores) to instruct a computing device to perform one or more actions. While various blocks are shown, a single medium may be configured with instructions to allow for, at least in part, performance of various actions of the method 410.

As described herein, one or more computer-readable media can include computer-executable instructions to instruct a computing system to: define a Radon transform convolution mask (see, e.g., blocks 414 and 416); specify an angle that defines a line extending at least partially across a pixel image (see, e.g., blocks 418 and 420); and apply the mask successively to target pixels on the line to compute a statistical value for each of the target pixels where application of the mask identifies a set of pixels for computing the statistical value and where each successive application of the mask identifies a set of pixels that includes at least one pixel of a prior set and at least one pixel not included in the prior set to thereby reduce requirements for computing the statistical values (see, e.g., blocks 422 and 424). In the example of FIG. 4, the method 410 may optionally compute at least two statistical values for each of the target pixels, for example, two statistical values for each target pixel may include a mean value and a variance value. In the example of FIG. 4, instructions may be provided to instruct a computing system to specify one or more additional angles and to apply the mask for the one or more additional angles.

As described herein, information from a Radon transform algorithm, such as statistical values, may be used, at least in part, to identify lines in a pixel image. As described herein, the Radon transform may include a line length parameter, a direction parameter and a location parameter. For example, an angle may specify the direction parameter of the Radon transform and a target pixel may specify the location parameter of the Radon transform.

As described herein, one or more computer-readable media may include computer-executable instructions to instruct a computing system to, for each target pixel, compare its statistical value or values (e.g., optionally via a cost function) to a previously computed value or values for the target pixel where the previously computed value or values correspond to a different angle. Such instructions may be configured to instruct a computing system to select an optimal angle for a target pixel based at least in part on a comparison of values.

As mentioned, instructions may be configured to instruct a computing system to, for each target pixel, compute a cost function where the cost function depends at least in part on a statistical value for a target pixel. For example, a cost function may depend on a mean and a variance for a target pixel.

While various examples pertain to 2D data, various techniques described herein may be applied to higher dimensional data. Further, an image may be a three-dimensional image where the pixels are voxels (volume elements).

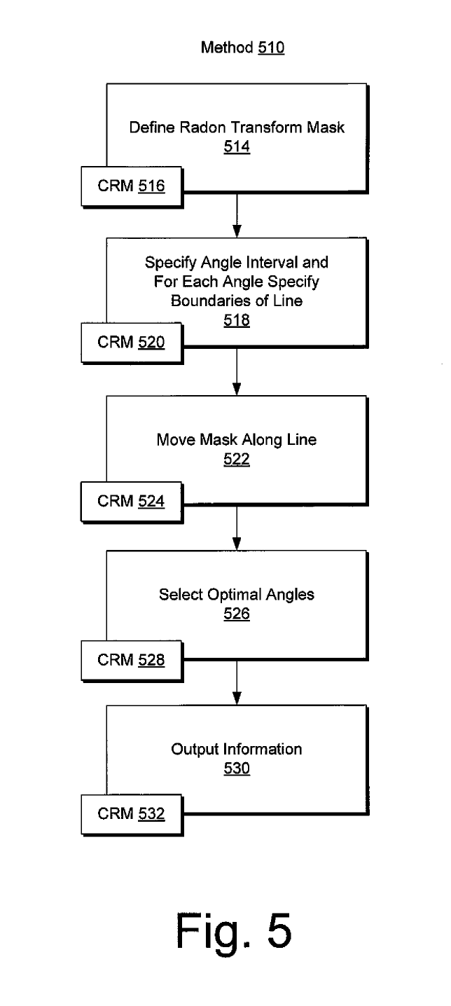

FIG. 5 shows an example of a method 510 for applying a mask to data. The method 510 includes a definition block 514 for defining a mask, a specification block 518 for specifying an angle interval (e.g., for defining directions for moving the mask with respect to the data) and that optionally specifies one or more boundaries for a line with respect to the data, a movement block 522 for moving a mask along a line, a selection block 526 for selecting optimal angles and an output block 530 for outputting information.

The method 510 is shown in FIG. 5 in association with various computer-readable media block 516, 520, 524, 528 and 532. Such blocks generally include instructions suitable for execution by one or more processors (or cores) to instruct a computing device to perform one or more actions. While various blocks are shown, a single medium may be configured with instructions to allow for, at least in part, performance of various actions of the method 510.

As described herein, a method for identifying lines includes defining a Radon transformation convolution mask (see, e.g., block 514 and 516); specifying angles where each angle defines a line with respect to a set of data (see, e.g., block 518 and 520); moving the mask along the lines to determine cost function values for various data coordinates for each of the angles where, along a line, the cost function value for a data coordinate is determined in part by one or more cost function variable values of an adjacent data coordinate (see, e.g., block 522 and 524); selecting optimal angles for at least some of the various data coordinates based at least in part on the cost function values (see, e.g., block 526 and 528); and outputting information sufficient to render an image to a display where the rendered image includes lines identified at least in part by the selected optimal angles.

As described herein, various techniques allow for implementation of the Radon transform in a more efficient manner, which can reduce requirements for computational resources. Further, various metrics generated via such techniques may be used in manners that can enhance analysis of data (e.g., 2D or 3D data).

The Radon transform (e.g., windowed Radon transform) can be described with respect to three input parameters for a convolution mask (or window): length (l pixels), direction (A angles) and location (the number of pixels in a data set, e.g., in an image M×N). With three parameters, it is possible to fix two and to vary the third. For example, by keeping the length fixed, an implementation may either iterate over possible directions of a line, or locations of a line. A brute force manner of implementing the Radon transform keeps location fixed, which makes it necessary to recompute the transform for all angles A. The resulting computational complexity for an image is on the order of l*A*M*N.

As described herein, where the direction is fixed, a convolution mask (or window) is traversed along that direction. In such an implementation, it becomes possible to reuse computations of pixels overlapping a current and the latest convolution mask since the kernel functions are linear. Accordingly, only 2 computations may be needed for one mask step, which corresponds to a computational complexity for the whole image on the order of 2*A*M*N. In terms of computation time, this may result in a decrease on the order of l/2. Such an approach is referred to herein, at times, as a sliding window approach.

With respect to angles, an algorithm may be configured to narrow down the angle domain of the Radon transform to either: 1) a global angle interval for the entire image or 2) an interval associated to each output pixel [θ_{min,l}, θ_{max,l}] (noting that symmetry of the Radon transform for angles modulo π allows for a smaller interval). Given a priori knowledge of an angle distribution for a data set (e.g., an image), results may be improved. For example, as described herein, an optimization process can be implemented to choose the best angle for each coordinate in a data set (e.g., 2D or 3D), which for image data, may correspond to a pixel.

As described herein, for each pixel at each angle, an implementation of the Radon transform can be used to compute a duple of mean and variance values. For all angles at each pixel, one of the duples is to be selected as the best value, which, for an image, will result in a 2D matrix of best values. One approach chooses the value according to the angle with the largest mean, unless the variance exceeds a cutoff (e.g., a predetermined variance value for a selection process). Such an approach gives strong lines but can have some issues with noise, especially around small areas containing more than one line. To reduce noise, one or more approaches may be taken. One approach considers that variance should be minimized, while the mean peak should be maximized. Accordingly, a local examination of variance and mean may be performed (e.g., within a specified distance from the pixel). Another approach involves determining whether or not a maximum is noise based on angle continuity (e.g., within a specified distance from the pixel). In general, it is unlikely that all three of mean, variance and angle are optimal at the same time. Accordingly, as described herein, an approach can apply weights to one or more of these variables, for example, as part of a cost function.

As described herein, one goal may be to detect edges (e.g., cracks, faults, etc. based on seismic data). To achieve this goal, peak detection may be used to generate lines or planes (e.g., in a 3D data set). In a 2D data set, a final result may be presented that consists of one-element thick lines extracted from the input data. Additionally, where a requirement sets forth that noise in the original image should not be carried over into output results, a peak detection step can be performed in which the optimized results (e.g., a 2D or 3D output array) are scanned for elements that stand out as local peaks. An algorithm may define a peak element, which typically make up, at least in part, output results.

Conventionally, the Radon transform has proven to be a general and helpful tool for finding lines in images. The Radon transform is based on convolution of an image with a kernel that gives high values at output pixels where a line is present and low values where line tendency is low. Often, data is preprocessed (e.g., with an edge enhancing filter to reduce noise affecting the output) prior to implementation of the Radon transform for line detection.

In image processing convolution is a transform that uses regional information when processing pixels. The region used as input for the transform, the convolution mask or kernel mask (or window), is typically defined in relation to a pixel being processed, which may be called the “output” pixel. A transformed value is generated through application of the kernel function or convolution function on the convolution mask.

As described herein, an implementation may consider a line l along the angle α, intersecting an output pixel x, where it is possible to parameterize the pixels p on the line in the Cartesian coordinate system (x₁, x₂) (e.g., or (x, y)) using a parameter t (e.g., p(x, t)=x+∇l*t) and restrict the pixels p to the set of lines of length l within the image (Img) by L(Img,l,x)={p(x,t): |t|≦[0.5*l],x εImg,p εl∩Img}, which corresponds to a convolution mask shaped as a line with output pixel x in the center.

In various implementations described herein, the Radon transform includes three kernel functions R_{μ}, Rᵥₐᵣ and a cost function over the convolution mask L. These functions correspond to the mean, variance and the cost function r_{ω}, an example of which is described further below. In such an approach, the mean is linear in the sum of the pixel intensities (or other data) and the number of elements and the variance is linear in the sum of the squares of the pixel intensities (or other data), the number of elements and the mean.

As described herein a sliding window (or mask) algorithm can be used to process an input array (e.g., 2D or 3D data). The following description provides details of an example of such an algorithm. The example implements the Radon transform with respect to a 2D data set, which is referred to as an image where detection of edges or lines is a goal (e.g., as to identify cracks in a 2D seismic data set).

In the example implementation, angles are selected from an angle interval that covers all of a pixel's angle intervals. The discretization of is accomplished through a uniform distribution of n angles from the smallest to the largest angle in the image, θₘᵢₙ and θₘₐₓ. This particular approach to discretize the image may miss some angles if n is not large enough. To cover the entire image (or selected portion of an image or data set), starting pixels of a line are selected in a manner that considers the boundary of the image, for example, as shown in Table 1.

TABLE 1
For each angle, a specific starting and ending boundary follows.

| gradient of line l | <0, * | ≠0, 0 | >0, * | 0, ≠0 |
|---|---|---|---|---|
| starting boundary: | Right | Left | Left | Bottom |
| ending boundary: | Left/Upper | Right | Right/Upper | Upper |

For a current output pixel, where the angle of the Radon transform is confirmed to be within the pixel's interval (e.g., −90° to +90° or other selected interval), processing can commence. To compute r_{μ}, and rᵥₐᵣ for that pixel, the following information is considered: (i) the number of pixels currently in the convolution mask (e.g., based on line length and angle); (ii) the sum of the pixel intensities; and (iii) the sum of the squares of the intensities. Accordingly, for each output pixel along the line, the implementation notes how many pixels are in the convolution mask and changes the sum of the intensities and the sum of the squares of the intensities based on which pixels are new to the mask, and which are no longer included in the mask.

In this example implementation, also computed is the cost function r_{w}. In such a manner, an optimization is included in implementation of the Radon transform, which can optionally avoid a need to perform a global optimization afterwards (e.g., which may be at the discretion of user, etc.). The foregoing approach that includes an optimization in the implementation of the Radon transform can also reduce memory complexity.

For example, to find the angle with the minimum cost for the output pixel, it can be compared to previous evaluations (e.g., previously determined for other angles of a particular output pixel). To avoid overhead, the cost value can be compared to zero plus an input constant C, initially (e.g., which may have a standard value of 0). If the image has large cost values, the optimum may be found by setting C to a high value; otherwise, they would be thresholded away. The cost results can be written to a final output image; noting that with an angle interval that is the same in the entire image, the code can be shortened substantially. As described herein, where such an approach to optimization is ongoing during implementation of the Radon transform, upon completion of the last angle for a pixel, the optimal result may be readily given for that pixel (e.g., the value for the last angle only needs to be compared to a stored best angle value).

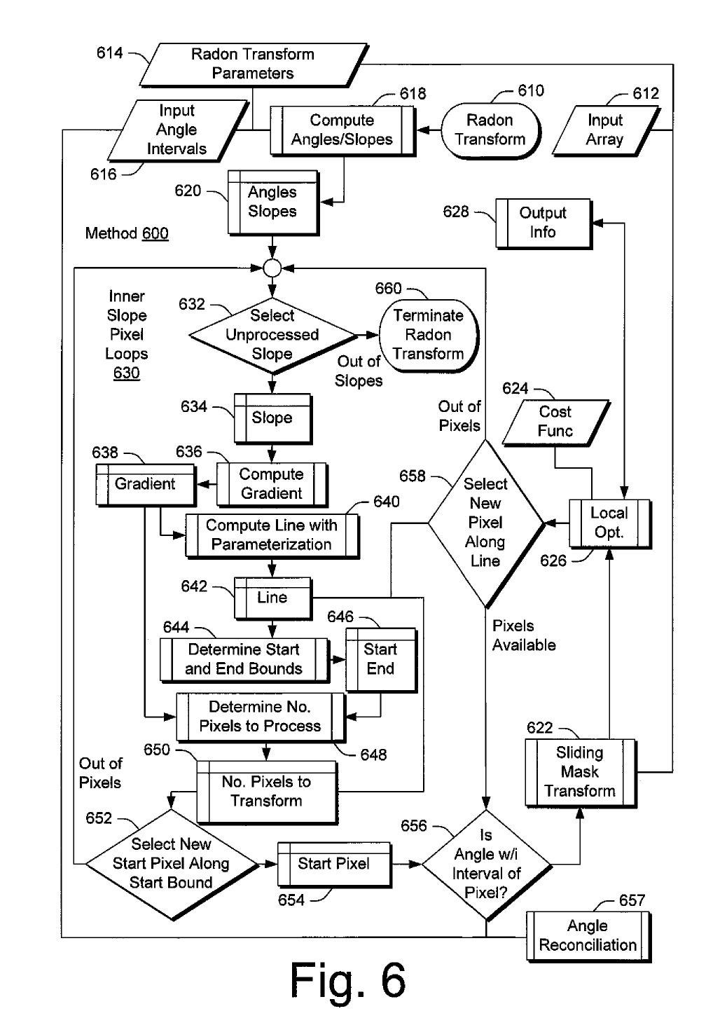

The example implementation is outlined below in pseudo-code and also presented in the form of a flow diagram in FIG. 6:

Let r_{μ}, rᵥₐᵣ, l, θₖ, θ_{min,i}, θ_{max,i} and Img be defined as the kernel functions of the Radon transform, a line along an angle, a selected angle between the largest and smallest angles, and an input array or image, respectively.
Let L be a convolution mask for a current output pixel and angle (e.g., not truncated to fit the image)
Let n be the number of pixels inside L
Let pᵢ be the current output pixel Let p_{front} and p_{back} be the pixel in the front and the back of L
Let P_{not in L} be the pixel that was p_{back} back in the latest step
Let s be the sum of the pixel values for the pixels in L
Let s² be the sum of the squared pixel values for the pixels in L
Let r_{ω}^{k,i} be the cost value for the angle θₖ and the output pixel pᵢ
Let r_{ω}ⁱ, initialized to zero, be the biggest cost value for pᵢ so far

```
for all angles θₖ do
  for all starting pixels according to Table 1 do
    while pᵢ ε I ∩ Img do
      if θₖ ∉ [θ_{min,i}, θ_{max,i}] then
        repeat
          Change pᵢ to the next pixel ε I ∩ Img
        until θₖ ε [θ_{min,i}, θ_{max,i}]
      end if
      Compute n, s, s², r_{μ} and rᵥₐᵣ
      if r_{ω}^{k,i} < r_{ω}ⁱ + C then
        Save r_{μ}, rᵥₐᵣ, r_{ω}^{k,i} and θₖ to the output images;
      end if
      Change pi to the next pixelε I ∩ Img
      while θₖ ε [θ_{min,i}, θ_{max,i}] do
        if p_{front} ε Img then
        n + +;
        s+ = Img(p_{front});
        s₂+ = Img²(p_{front})
        end if
        if p ∉ L ε Img then
        n − −;
        s− = Img(p ∉ L);
        s₂− = Img²(p ∉ L);
        end if
        if n has been reevaluated then
        r_{μ} = s/n;
        rᵥₐᵣ = s₂/n − r_{μ}²;
        end if
        if r_{ω}^{k,i} < r_{ω}ⁱ + C then
          Save r_{μ}, rᵥₐᵣ, r_{ω}^{k,i} and θₖ to the output images;
        end if
        Change pᵢ to the next pixel ε I ∩ Img
      end while
    end while
  end for
end for
```

FIG. 6 shows an example of a method 600 that corresponds to the foregoing pseudo-code. The method 600 includes various blocks that have shapes corresponding to data, parameters, processes, decisions, etc. The method 600 commences with a Radon transform block 610 and an input array 612, which along with various other blocks 614-628 support blocks 632-660 of so-called inner slope and pixel loops 630. As indicated decisions blocks 632, 652 and 658 decide whether slopes or pixels are available for processing. Where all slopes have been processed, per the decision block 632, the method 600 terminates at a Radon transformation termination block 660 with results in a data store 628 (“output info”).

As mentioned, the example implementation includes an optimization within the Radon transform, which is represented in the method 600 of FIG. 6 by the cost function 624 and local optimization blocks 626; noting that a sliding mask transform block 622 includes information from the input array block 612 and the Radon transform parameters block 614 as well as a go-ahead from the decision block 656 (“is angle within interval of pixel?”) and provides information to the local optimization block 626.

As shown in FIG. 6, the method 600 includes a commencement block 610 that commences a process that implements the Radon transform for processing information in the input array 612, for example, according to the Radon transform parameters 614. In a compute block 618, angles and slopes are computed, as represented by a data block 620. The method 600 enters the inner loops 630 for processing slopes and pixels associated with those slopes. The loops 630 include the decision block 632 which acts to select an unprocessed slope, which is represented by a data block 634. The slope is relied on by a compute block 636 that computes a gradient, represented by a data block 638. The gradient is relied on by a compute line with parameterization block 640 and a determination block 648. These blocks generate data for a line and the number of pixels to transform, respectively, in conjunction with a determination block 644 that determines start and end bounds for a line, as represented by data block 646.

In the decision block 652, a start pixel is selected, as represented by the data block 654. The decision block 656 decides if the angle is within the interval of the selected pixel. If so, the sliding mask transform block 622 computes information for the local optimization block 626, which applies the cost function 624. In operation, information may flow back and forth from the data store 628 to the local optimization block 628, which may depend on specifics of the cost function 624 and approach to local optimization. For example, if a previously computed result is required for local optimization with respect to a current pixel, then the local optimization block 626 may access the data store 624 (e.g., memory) to acquire one or more values (e.g., a current “best” value for an angle associated with a pixel). Once the local optimization block 626 outputs information for the selected pixel, the method 600 continues at the decision block 658, which decides to select a new pixel along the line (e.g., the line represented by the data block 642). Where pixels are available, the method 600 continues to the decision block 656, which has been described above. A block 657 addresses instances when the angle is not within the interval of the selected pixel (e.g., angle reconciliation, which may optionally skip to another point in the method 600).

In various trials, the aforementioned sliding window Radon transform algorithm was ported to a C program, which was configured to read an edge enhanced input array, perform the Radon transform with optimization and output results to a data file of a data storage device. In this particular trial implementation, memory was allocated and freed manually; noting that the syntax of matrices and arrays differs somewhat from the C# syntax.

As described herein, to pick the best angle a selection procedure must be performed. Various different optimization techniques may be used, such as, a local cost function to pick the optimal value for each pixel, a global weakest link technique or a global full line technique.

For global optimization, mean and variance values must be available. Such an approach was implemented using an additional dimension (e.g., a third dimension for a 2D data set) where the additional dimension was n wide, where n corresponds to the number of angles. In a particular trial, n was 37.

In a trial, a local optimization technique was implemented that ignored the angle continuity. The trial used a cost function r_{ω}=w*rᵥₐᵣ−r_{μ}, where r_{ω} was the cost, w was the weight, rᵥₐᵣ was the variance and r_{μ} was the mean). The foregoing example cost function is to be minimized to achieve a small variance and a large mean. A threshold effect approach, as described above, resulted in good noise reducing effects in trial images, although care should be considered in instances where a threshold may act to remove lines in images that have higher variance. In various trials, the constant C was introduced, as already described, to counter such unwanted effects.

As described herein, labeling of pixels may occur based at least in part on mean, variance, mean and variance and optionally with respect to local, global or local and global factors. For example, while line detection can benefit from examination of small variance and large mean, identification of noise such as speckle noise may benefit from examination of large variance and large mean. Accordingly, an approach may include criteria for line detection and criteria for identification of speckle noise. Such criteria may be optionally implemented in parallel or in series (e.g., if not the “best”, is it noise?). As described herein, such criteria may optionally be implemented in the form of one or more cost functions. While speckle noise is mentioned, criteria that act to identify other types of artifacts or features may be included. Accordingly, the Radon transform approach described herein can be adapted for purposes other than line detection. Of course, line detection and one or more other purposes may be accomplished in an essentially simultaneous manner using any of a variety of statistical or other metrics that can be readily computing using the sliding mask (or window) approach described herein.

In the trial implementations, mask coordinates were calculated according to angle. The method then iterated over the mask and calculated the cost for each pixel using the aforementioned cost function: r_{ω}=w*rᵥₐᵣ−r_{μ}. The method picked the largest cost value on the mask as the weakest link and the angle with the lowest weakest link value was chosen the optimum. The mean and variance values according for the selected angle (lowest weakest link value) was stored in an output matrix.

For a full-line cost function implementation, the mask coordinates were calculated in the same way as in the weakest link approach. However, instead of using the worst value, all cost values from the cost function (r_{ω}=w*rᵥₐᵣ−r_{μ}) were summed over the mask. The angle with the lowest sum was considered optimal and the mean and variance values that corresponded to the angle with the lowest sum were selected and stored.

An example of a local optimization was implemented that did not require a mask to be calculated. The approach used the aforementioned cost function (r_{ω}=w*rᵥₐᵣ−r_{μ}) to select the optimal value. The least cost was used without any other alterations of the cost function. In this example of a local optimization, no additional dimension for the mean and variance matrices was needed because the cost could be calculated during the sliding window step, which saved on memory requirements.

As described herein, another approach implemented peak detection algorithms (PDAs). All of the PDAs implemented have a parameter R which denotes the radius of the operation. The radius is interpreted as the number of elements in each direction which are included in the operation. In the examples implemented, the center element was always included and the default radius was set to 3.

A parameter “PixelStep” was introduced to determine how many pixels to step between each peak detection operation. A parameter “SampleStep” was also introduced for how many pixels to step between each sample within the set of data in the current peak detection operation. With a higher PixelStep there will be fewer operations and with a higher SampleStep every operation will be smaller. Both parameters had a default value set to 1.

For a maximum search along a line using the PDAs, one horizontal and one vertical, compares each element in the matrix to every neighbor along a centered line extending R steps in both directions. Accordingly, if the element value is greater than all other along the line, it is considered a peak and, for example, it is copied to a results matrix. This particular approach can be described by the following pseudo-code:

```
For all elements e in original matrix A do
  Determine a sampling domain S around ε based on radius R
  Let sₘₐₓ = 0 be the sample maximum
  for all sample values s in S do
    if s > smax then
      smax = s
    end if
  end for
  if ε > smax then
    Copy ε to the result matrix B
  end if
end for
```

Another approach relies on least-squares fitting to a quadratic curve. In this approach, for every element in a matrix the algorithm uses a least-squares technique to fit a quadratic function of the form f(t)=b₀+b₁t+b₂t² to the data values along a line (e.g., horizontally or vertically). The line extends a set number of elements away from the current pixel. If the coefficient b₂ is negative, the function f has a maximum at tₘₐₓ=−(0.5)(b₁/b₂), which is derived by setting the derivative to zero. If this point lies within the current set of data values, the point is classified as a local peak and the data at this point is copied to a results matrix. In general, the algorithm does not consider extreme points on the boundary of the current set because such effects are expected to be handled in passes with origin elements closer to that point. The following pseudo-code describes such a process:

```
For all elements e in original matrix A do
  Matrix X and vectors b and y
  Determine a sampling domain S around elm based on radius R
  for all sample values s in S do
    Construct one row of the transposed LHS matrix X
    Copy s to one element of the transposed RHS vector y
  end for
  Compute the least-squares solution to the system
  b holds the coefficients of quadratic function f(t)
  if f(t) has a maximum in S then
    Copy f(tₘₐₓ) to the result matrix B
  end if
end for
```

Another approach uses a least-squares fitting technique in a tilted domain. This algorithm can be implemented generally according to the foregoing algorithm (see quadratic curve fitting) with the addition that it selects data values from a domain line that is tilted at an angle, which may be an arbitrary angle. Such an approach can be useful in cases where the line tendencies in an original image change in different areas such that no constant direction would suit the entire image (or portion thereof that is of interest). In the titled domain approach, an expected line direction can be provided per-pixel where the algorithm scans perpendicularly to that direction for each processed pixel. As this approach requires trigonometric computations to resolve the domain at each pixel, it may not be optimal for use with images with slanted but constant line directions. In such instances, a pre-rotation of the image that aligns the expected line direction with the horizontal or vertical direction may prove to be more efficient.

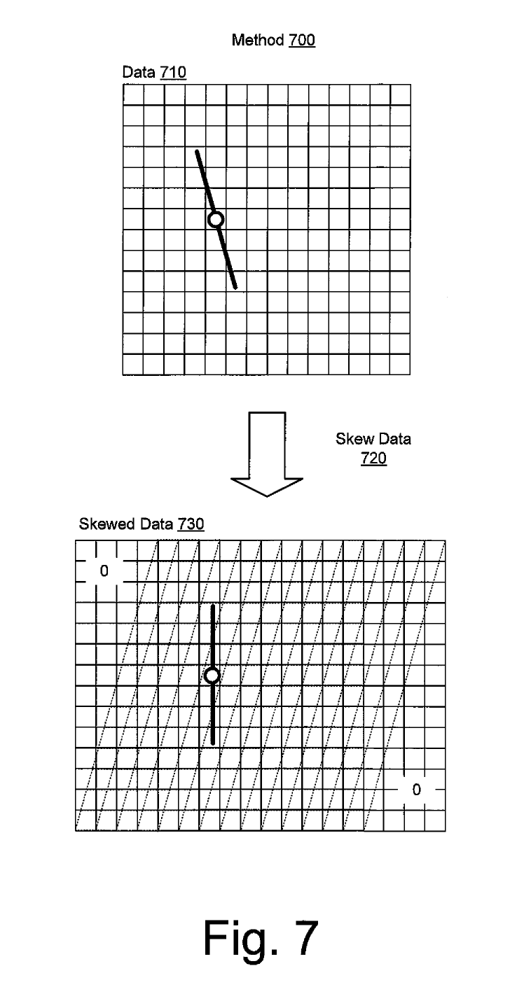

FIG. 7 shows an example of a method 700 that includes tilting or skewing process 720 that receives data 710 and produces skewed data 730. In the example of FIG. 7, the skewed data matrix 730 is larger than the original data matrix 710 and it includes zero-filled or zero-padded regions. As in most data manipulation processes, some computational error may be expected (e.g., consider skewing an image followed by deskewing, which may not return the original pixel values of the image). However, once skewing occurs for an angle, the algorithm may proceed with more efficiency than, for example, the algorithm outlined in FIG. 6 as certain computations and checks may no longer be required.

A particular implementation used a least-squares fitting technique as part of a peak detection algorithm (PDA). As mentioned, some PDAs may use least-squares fitting of data to a quadratic function to analyze the data for peaks. In a particular example, such an approach was implemented where fitting was performed by constructing a matrix X which contains a row vector with the values (1, t, t²) for each coordinate of the data. In such an approach, if b is a column vector with the coefficients bₙ and y is a column vector with all the data values, then Xb=y is an overdetermined system for the vector b. By QR-decomposition of X, Rb=Q^{T}y, which is a well determined system of equations that minimizes the two-norm of Xb−y. Since R is an upper-triangular matrix b can be computed directly without elimination. The QR-decomposition of X can be performed, for example, using Gram-Schmidt-orthogonalization. Note that such an implementation solves the transpose of the problem in order to use row-vector operations to improve cache efficiency. Pseudo-code describing the foregoing example follows:

Ingoing system matrix X, coefficient vector b and value vector y
Let N_{y} be the number of elements in y
Let N_{b} be the number of elements in b
Define matrix Q with size N_{y}×N_{y}
Define matrix R with size N_{b}×N_{b}
{Compute QR-decomposition using Gram-Schmidt-orthogonalization}

```
for n = 0 to N_{b} do
  Qₙ = Xₙ
  for I = 0 to n − 1 do
    Qₙ = Qₙ − <Qₙ, Q_{I}>Q_{I}
    R_{n,I} = <Qₙ, Q_{I}>
  end for
  R_{n,n} = (Qₙ, Qₙ)^{0.5}
  Qₙ = Qₙ/R_{n,n}
end for
```

{Solve overdetermined system using forward substitution}

```
for n = N_{b} − 1 to 0 do
  for k = N_{b} − 1 to n + 1 do
    Decrease bₙ by R_{k,n}bₖ
  end for
  bₙ = (bₙ − <y,Qₙ>)/R_{n,n}
end for
```

Trial results were generated for implementation of the Radon transform using a sliding window algorithm. One trial implementation used the same angle span over the whole input image data set, and thus did not need to check for the angle span for each pixel. Another trial implementation used different angle spans for each pixel, which required more resources.

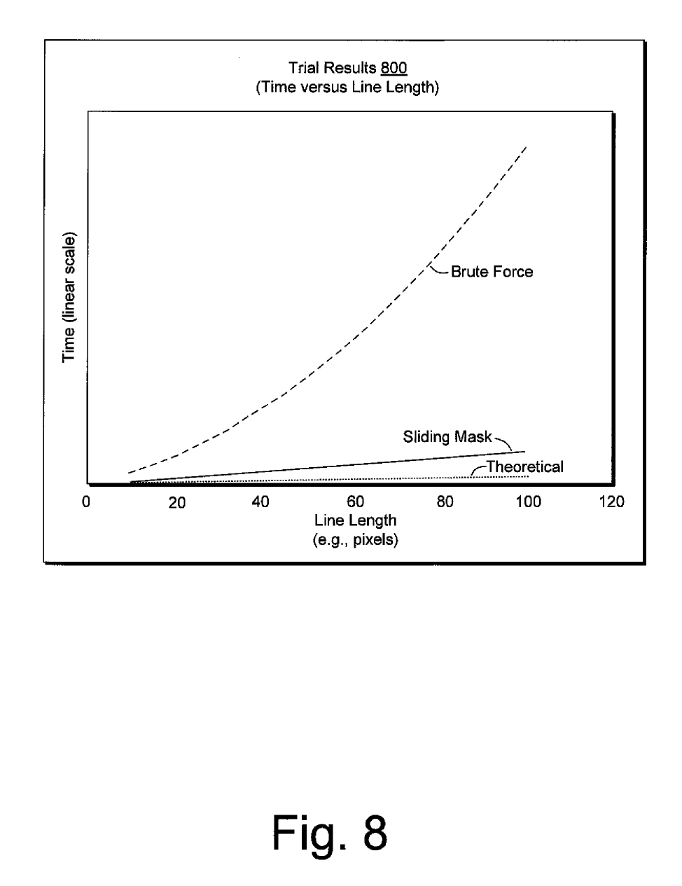

In trial implementations, a script looped the Radon transform over different line lengths and saved the times in a file. The line interval 10-100 was chosen since it covered over three octaves. A step length of 5 pixels gave the interval [10, 15, 20, . . . , 90, 95, 100]. The script ran over 50 intervals. The minimum values for each length were used for comparison. In trials, the fastest values occurred when the runs had the least interference from other running applications on the computing device. The times and the line length were used to create the plot of trial results 800 of FIG. 8. These results were acquired using a PC configured with an INTEL® Core2 Quad CPU Q9400 2.67 GHz with 4 GB of RAM (WINDOWS® 7 OS, Professional 64-bit and MICROSOFT® Visual Studio 2008 Professional Edition compiler).

Another approach involved implementation of the Radon transform where only lines along the angle interval specified by each pixel were selected. Trials demonstrated a slower speed than the other approach that depended highly on the distribution of the angle intervals.

In various trials, with respect to optimizations, the weakest link and full line methods executed about 10 times slower than the local method. The weakest link approach made calculations that were superfluous. With an appropriately selected weight, noise was reduced; noting that all methods provided qualitatively good results. For the global techniques, ends of some lines were shortened without any noticeable insufficiencies.

In trial implementations, the local method used simple binary operations, which allowed for more rapid computations. Where a suitable weight value was used, results demonstrated marked lines and low noise. In a trial implementation, global methods were removed and the associated 3D matrix was changed to a 2D matrix; best values were selected during running of the algorithm. From this approach a noticeable increase in speed (decreased computation time) was measured; it also saved significantly on memory.

In various trials, it was noted that the weight parameter had a large effect on the output data. As noted, when the global optimization methods were removed the memory consumption became smaller. For the weighted approach described above (i.e., weight “w”), noise was filtered by a selecting a large value. However, large values for w result in some lines becoming less defined in noisy areas. Accordingly, the weight w should be selected for suitable noise reduction while still producing well-marked lines. Trials implemented values for w between 1 and 10. The standard value was chosen to be 5, but this value could be modified as appropriate (e.g., tuned). The effects of the weight in the mean value images are presented in Table 2.

TABLE 2
Effect of different weights in mean value BMP.

| Weight | Line quality | Noise | Note |
|---|---|---|---|
| 1 | Very high | Over the entire image | Looks like BF |
| 3 | Very high | A lot close to lines | |
| 5 | High | Some close to the lines | Standard value |
| 6 | Middle | Some between close lines | |
| 9 | Low | A little between lines | |
| >10 | Very low | Almost none | Erroneous Lines |

Various trials were run that were based on applying the horizontal and vertical search operations and the horizontal and vertical least-squares operations to the original image on the left with the detection radius R=10, PixelStep=1 and SampleStep=1.

In a comparison of horizontal versus vertical sample domains, the horizontal search and least-squares algorithms produce discernible lines from the input data while the corresponding vertical algorithms produced more noise. This is in part due to the fact that the line tendencies in the original data were towards vertical and the best results were obtained when using a sample domain perpendicular to the tendencies. If the sample domain is tangential to the lines it is likely to cancel several line elements in one operation step, for example, only selecting one of them as a peak. A more optimal situation is to have only one line element in the sample domain so that it can be correctly selected as the peak element.

In various trial implementations, a criterion was used that stated that detected lines should be no wider than one element (e.g., one pixel). With this criterion, trial results demonstrated that the search-based algorithms comply while the least-squares-based algorithms do not. As described herein, such a criterion was used for a particular purpose and may be optional or one or more other criteria may be used (e.g., where width depends on another factor, depending of whether lines, noise or other features are of interest, etc.).

In various trial implementations, a horizontal least-squares algorithm produced results where, in the gaps between lines, there was no significant noise. This result is at least in part due to the fact that single noise elements do not contribute much to the quadratic function. While some noise exists around detected lines, this is introduced within the algorithm rather than carried over from the original data. In another approach, a horizontal search algorithm did not cancel ingoing noise and tended to pick up short line segments from noise in areas far from real lines. This is at least in part because with no real line element within the sample domain the approach picks up noise elements as peaks instead. It also tends to break off real lines when there are noise elements close by with greater value than the line element. For the data sets used in the trials, the vertical algorithms were more difficult to evaluate because of significant noise.

As described herein, an approach may implement a two-pass peak detection process. For example, to fulfill both the requirement that lines should be one element wide and that original noise should be suppressed a two-pass operation may be used. The foregoing requirements are met by first running a least-squares-based algorithm, then performing a mean-filter on the result and finally running a search-based algorithm on the filtered result. The least-squares algorithm removes noise and concentrates data around the lines. The mean filter smoothes the noise introduced by the least-squares operation. Finally the search-algorithm narrows the smoothed lines to one pixel in width. Accordingly, by using a combination of a search-based and a least-squares-based PDA noise was reduced and lines were kept sharp for particular sets of input data.

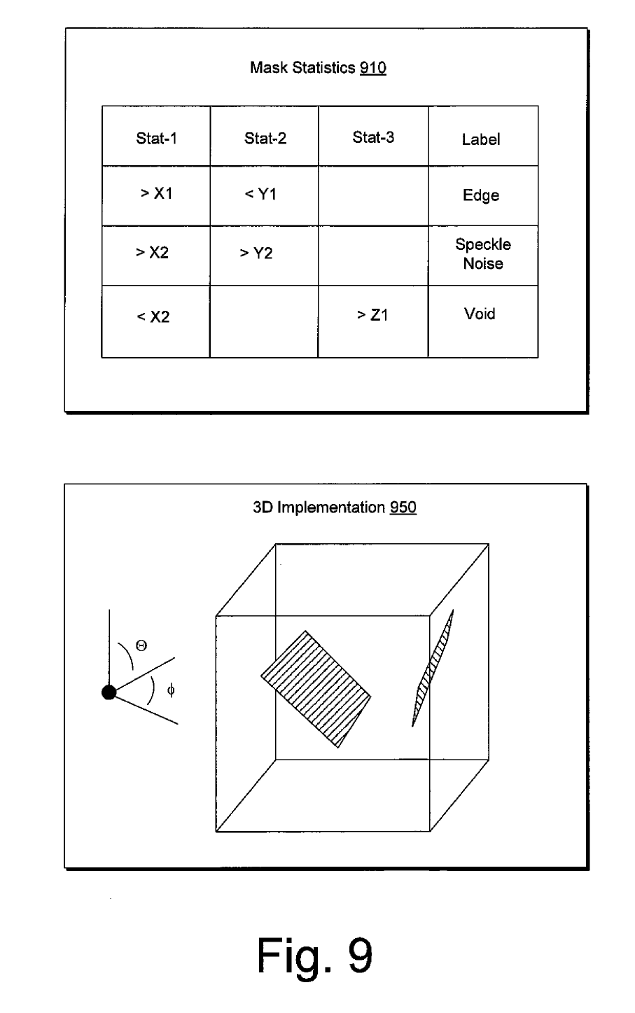

FIG. 9 shows a mask statistics approach 910 example and a 3D implementation 950 example. In the mask statistics approach 910, one or more statistics or other values computed based on information in an input data set may be determined using a mask such as the sliding mask described herein. One or more criteria may be used to analyze one or more of these values to decide whether a label should be applied to a datum or coordinate. For example, a label may be an “edge”, “speckle noise”, “void”, etc. The labels may depend on the original data, for example, whether it is image data, physical data, etc. and how the data may have been treated (e.g., filtered to enhance edges). Certain edge enhancement techniques as well as other image processing techniques can generate particular types of artifacts. As described herein, statistics or other formulas may be applied to data in a mask where the resulting values may be used to label a datum, data, a coordinate, a region, etc. Such an approach may rely on one or more relative values (e.g., from other data or analyzed data), may rely on one or more predetermined values (e.g., knowing characteristics of an 8 bit data set) or rely on a combination of both relative and predetermined values. For example, consider implementing a Radon transform to label pixels in an image as being associated with mosquito noise, which is a distortion that appears near crisp edges of objects in MPEG and other video frames that are compressed with the discrete cosine transform (DCT). Mosquito noise occurs at decompression when the decoding engine has to approximate the discarded data by inverting the transform model. A priori knowledge of characteristics of mosquito noise (e.g., due to type of image, contrast in image, type of DCT process, type of computer, etc.) may be used to determine one or more mask statistics and associated criteria for use in labeling pixels as being due to mosquito noise.

As mentioned, various techniques described herein may be applied or adapted for use on data sets having more than two dimensions. The example of FIG. 9 shows a 3D data set where planes have been identified. In such an implementation, another set of angles may be introduced such that the Radon transform is applied twice across a 3D data set. Optimization may be local, global or a combination of local and global.

As described herein, one or more computer-readable media may include computer-executable instructions to instruct a computing system to output information for controlling a process. For example, such instructions may provide for output to sensing process, an injection process, drilling process, an extraction process, etc.

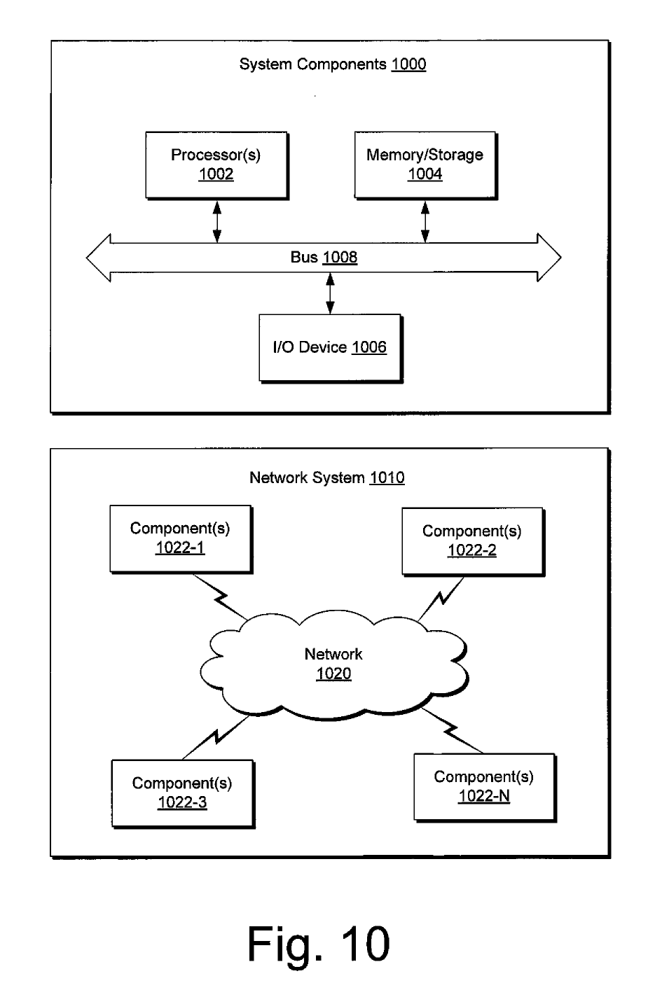

FIG. 10 shows components of a computing system 1000 and a networked system 1010 (e.g., optionally configured to provide for implementation of one or more components of the system 100 of FIG. 1). The system 1000 includes one or more processors 1002, memory and/or storage components 1004, one or more input and/or output devices 1006 and a bus 1008. As described herein, instructions may be stored in one or more computer-readable media (e.g., memory/storage components 1004). Such instructions may be read by one or more processors (e.g., the processor(s) 1002) via a communication bus (e.g., the bus 1008), which may be wired or wireless. The one or more processors may execute such instructions to implement (wholly or in part) one or more attributes (e.g., as part of a method). A user may view output from and interact with a process via an I/O device (e.g., the device 1006). As described herein, a computer-readable medium may be a storage component such as a physical memory storage device, for example, a chip, a chip on a package, a memory card, etc.

As described herein, components may be distributed, such as in the network system 1010. The network system 1010 includes components 1022-1, 1022-2, 1022-3, . . . 1022-N. For example, the components 1022-1 may include the processor(s) 1002 while the component(s) 1022-3 may include memory accessible by the processor(s) 1002. Further, the component(s) 1002-2 may include an I/O device for display and optionally interaction with a method. The network may be or include the Internet, an intranet, a cellular network, a satellite network, etc.

### CONCLUSION

Although various methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

1. One or more computer-readable media comprising computer-executable instructions to instruct a computing system to:
define a Radon transform convolution mask;
specify an angle that defines a line extending at least partially across a pixel image; and
apply the mask successively to target pixels on the line to compute a statistical value for each of the target pixels wherein application of the mask identifies a set of pixels for computing the statistical value and wherein each successive application of the mask identifies a set of pixels that includes at least one pixel of a prior set and at least one pixel not included in the prior set to thereby reduce requirements for computing the statistical values.

2. The one or more computer-readable media of claim 1 further comprising computer-executable instructions to instruct a computing system to compute at least two statistical values for each target pixel.

3. The one or more computer-readable media of claim 2 wherein the least two statistical values for each target pixel comprise a mean value and a variance value.

4. The one or more computer-readable media of claim 1 wherein the pixel image comprises a seismic image.

5. The one or more computer-readable media of claim 1 further comprising computer-executable instructions to instruct a computing system to identify lines in the pixel image based at least in part on the statistical values.

6. The one or more computer-readable media of claim 1 wherein the Radon transform comprises a line length parameter, a direction parameter and a location parameter.

7. The one or more computer-readable media of claim 6 wherein the angle specifies the direction parameter of the Radon transform.

8. The one or more computer-readable media of claim 6 wherein the target pixel specifies the location parameter of the Radon transform.

9. The one or more computer-readable media of claim 1 further comprising computer-executable instructions to instruct a computing system to, for each target pixel, compare its statistical value to a previously computed statistical value for the target pixel wherein the previously computed statistical value corresponds to a different angle.

10. The one or more computer-readable media of claim 9 further comprising computer-executable instructions to instruct a computing system to select an optimal angle for a target pixel based at least in part on a comparison of statistical values.

11. The one or more computer-readable media of claim 1 further comprising computer-executable instructions to instruct a computing system to, for each target pixel, compute a cost function wherein the cost function depends at least in part on a statistical value for a target pixel.

12. The one or more computer-readable media of claim 11 wherein the cost function depends on a mean and a variance for a target pixel.

13. The one or more computer-readable media of claim 1 further comprising computer-executable instructions to instruct a computing system to specify one or more additional angles and to apply the mask for the one or more additional angles.

14. The one or more computer-readable media of claim 1 wherein the pixel image comprises a three-dimensional image.

15. A method for identifying lines comprising:
defining a Radon transformation convolution mask;
specifying angles wherein each angle defines a line with respect to a set of data;
moving the mask along the lines to determine cost function values for various data coordinates for each of the angles wherein, along a line, the cost function value for a data coordinate is determined in part by one or more cost function variable values of an adjacent data coordinate;
selecting optimal angles for at least some of the various data coordinates based at least in part on the cost function values; and
outputting information sufficient to render an image to a display where the rendered image comprises lines identified at least in part by the selected optimal angles.

16. The method of claim 15 wherein the set of data comprises a three-dimensional set of data.

17. The method of claim 16 wherein the angles comprise angles in two, two-dimensional planes.

18. One or more computer-readable media comprising computer-executable instructions to instruct a computing system to:
receive data about a geologic environment;
enhance the data using an edge enhancement technique;
execute the Radon transform with a convolution mask that moves along lines defined by angles to generate results;
process results of the Radon transform to identify geological features and artifacts in the data; and
output information sufficient to render the identified geological features to a display.

19. The one or more computer-readable media of claim 18 wherein the artifacts comprise noise.

20. The one or more computer-readable media of claim 18 further comprising computer-executable instructions to instruct a computing system to compute mean and variance and to identify lines as being characterized by a high mean and a low variance and to identify speckle noise as being characterized by a high mean and a high variance.
